(19) United States
(12) Patent Application Publication
(10) Pub. No.: US 2014/0082481 A1
(43) Pub. Date: Mar. 20, 2014

(54) DOCUMENT PROCESSING DEVICE AND COMPUTER PROGRAM PRODUCT

(71) Applicant: KABUSHIKI KAISHA TOSHBA, Tokyo (JP)

(72) Inventor: Yusuke DOI, Kanagawa (JP)

(73) Assignee: KABUSHIKI KAISHA TOSHBA, Tokyo (JP)

(21) Appl. No.: 14/027,658

(22) Filed: Sep. 16, 2013

(30) Foreign Application Priority Data
Sep. 18, 2012 (JP) 2012-204591

(51) Int. Cl. G06F 17/22

(52) U.S. Cl. CPC G06F 17/2247
USPC 715/234

(57) ABSTRACT

According to an embodiment, a query element determining unit and an exit condition determining unit. The query element determining unit is configured to determine whether an attribute, element, or value corresponding to query's interest in a received structured document is satisfied for each of query elements into which query data for specifying conditions for the structured document is broken down for respective conditions, output one of a positive output indicating that a condition is satisfied, a negative output indicating that a condition is not satisfied, and a standby output indicating that a condition is not allowed to be determined yet as an output value, and output the standby output until the positive or negative output is output. The exit condition determining unit is configured to output one of a positive output, a negative output, and a standby output as an output value of an exit condition.

### CROSS-REFERENCE TO RELATED APPLICATION

This application is based upon and claims the benefit of priority from Japanese Patent Application No. 2012-204591, filed on Sep. 18, 2012; the entire contents of which are incorporated herein by reference.

### FIELD

Embodiments described herein relate generally to a document processing device and a computer program product.

### BACKGROUND

There has been an increasing trend in the data amount of structured documents in XML and the like, and the structured documents are thus not suitable for high-speed data processing and processing handling a large amount of XML documents. Efficient XML Interchange (EXI) is therefore proposed as a standard for efficient and high-speed data processing. The EXI converts an XML document to an EXI stream that is a binarized representation according to the XML schema. This can contribute to efficient data communication and processing since binarized data are dramatically reduced in data volume.

A possible example of data processing using the EXI stream is a case of extracting only data matching a certain condition by filtering from large quantities of EXI stream that is binarized and transmitted, and processing only necessary data. There has been disclosed, however, no method for processing documents that is optimized for processing such large quantities of data

### BRIEF DESCRIPTION OF THE DRAWINGS

FIG. 1 is a diagram illustrating an example of connection of a document processing device according to an embodiment;

FIG. 2 is a diagram illustrating a detailed functional configuration of the document processing device according to the embodiment;

FIG. 3 illustrates an example of an XML schema according to the embodiment;

FIGS. 4A and 4B illustrate examples of an EXI stream according to the embodiment;

FIG. 5 is a flowchart illustrating a flow of document processing according to the embodiment; and

FIG. 6 is a flowchart illustrating another example of a flow of document processing according to the embodiment.

### DETAILED DESCRIPTION

According to an embodiment, a document processing device includes a state machine storage unit, a document storage unit, a document receiving unit, a state transition executing unit, a query element determining unit, an exit condition determining unit, and an output unit. The state machine storage unit is configured to store a state machine generated from a grammar defining a structured document. The document storage unit is configured to store a binarized structured document being processed. The document receiving unit is configured to receive an input of the structured document, and store the structured document into the document storage unit. The state transition executing unit is configured to execute a state transition of the structured document stored in the document storage unit according to the stored state machine associated with the structured document, and update a current state of the structured document stored in the document storage unit each time a transition is executed. The query element determining unit is configured to determine whether an attribute, element, or value corresponding to query's interest in the received structured document is satisfied for each of query elements into which query data for specifying conditions for the structured document is broken down for respective conditions, output one of a positive output indicating that a condition is satisfied, a negative output indicating that a condition is not satisfied, and a standby output indicating that a condition is not allowed to be determined yet as an output value, and output the standby output until the positive output or the negative output is output. The exit condition determining unit is configured to output one of a positive output indicating that a condition is satisfied, a negative output indicating that a condition is not satisfied, and a standby output indicating that a condition is not allowed to be determined yet as an output value of an exit condition expressed by a logical expression combining conditions of the output values output from the query element determining unit, the exit condition expressing whether the received structured document satisfies the conditions of the query data. The output unit is configured to output the structured document. The state transition executing unit executes the transition while the exit condition determining unit outputs the standby output, and discards the received structured document being processed and instructs the document receiving unit to receive a next structured document when the exit condition determining unit outputs the negative output. The output unit outputs the structured document being processed when the exit condition determining unit outputs the positive output.

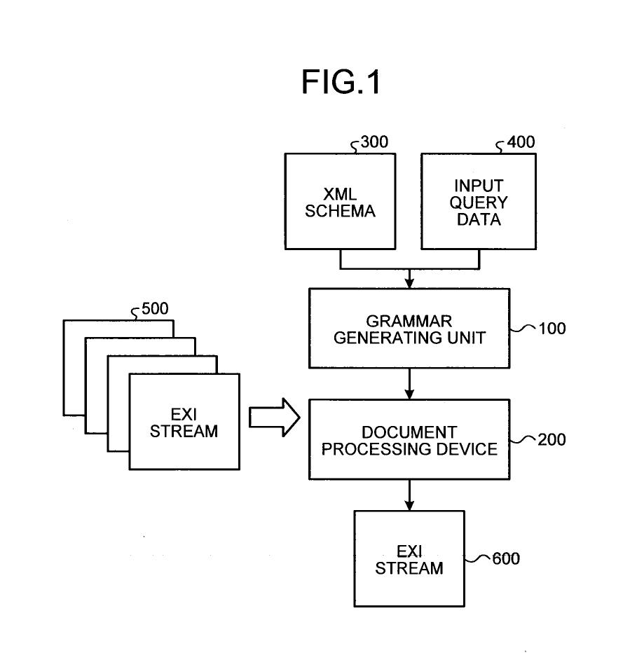

FIG. 1 is a block diagram illustrating a configuration of a document processing device according to a first embodiment. In the present embodiment, a configuration for processing a structured document in XML binarized according to the EXI standard is presented. An XML schema is therefore employed as the schema in the present embodiment, but another grammar such as RELAX NG defining a structure document may be employed. Furthermore, the structured document may be another type of structured element such as that in ASN.1 instead of the XML, and any format of structured documents that can be expressed by a grammar as a state machine. Furthermore, although the EXI is employed for input/output to the document processing device, another standard may be used.

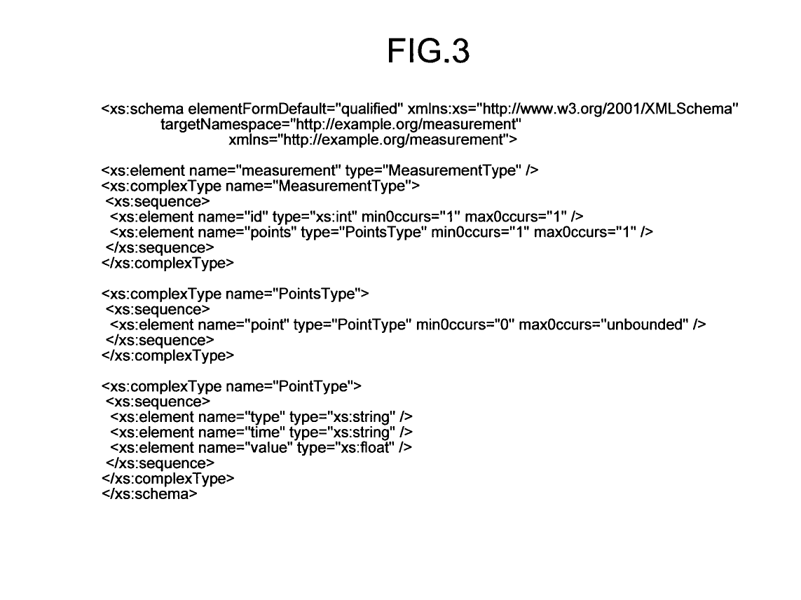

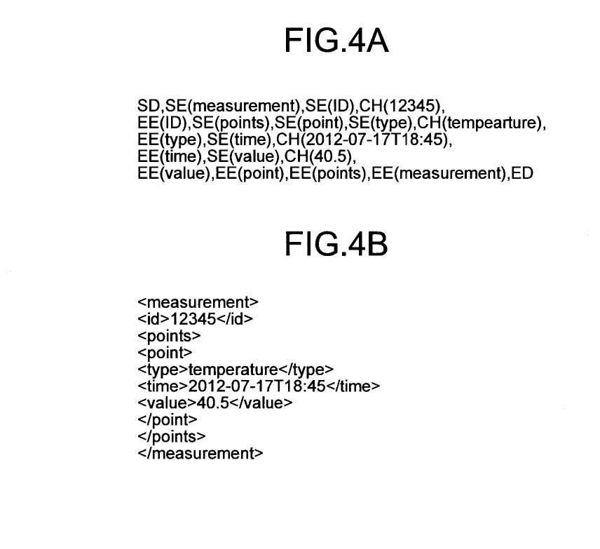

As illustrated in FIG. 1, an EXI stream 500 is input to the document processing device 200 in the present embodiment. In addition, a state machine with an exit condition generated by a grammar generating unit 100 on the basis of an XML schema 300 and input query data 400 is input to the document processing device 200. The document processing device 200 then outputs an EXI stream 600 resulting from filtering by the state machine with an exit condition. FIG. 3 illustrates an example of the XML schema, FIG. 4A illustrates an example of a structured document expressed by an event sequence defined by the EXI, and FIG. 4B illustrates an example of a document expressing the document in FIG. 4A in an XML format.

The XML schema in the example illustrated in FIG. 3 is a grammar defining three types of elements: MeasurementType, PointsType, and PointType. In addition, a query indicating to “narrow down to structured documents in which the value of /measurement/points/point/type is temperature and the value of /measurement/points/point/value is equal to or larger than 40” is provided as the input query data 400 in the present embodiment.

The grammar generating unit 100 generates a state machine with an exit condition from the XML schema 300 and the input query data 400, and inputs the generated state machine with an exit condition to the document processing device 200. Details of the generation of a state machine with an exit condition will be described below. A state machine with an exit condition is obtained by adding an exit condition to a state machine in an XML schema. Specifically, a state machine with an exit condition contains a state machine associated with the XML schema 300, one or more query elements that are condition determination elements obtained by breaking down the input query data, and an exit condition that can be expressed by a logical expression combining query elements.

A state machine refers to an expression of a grammar including three tables, which are a type grammar table, a state table, and a transition table, for example, but may be any kind of state machine. Note that, in the present embodiment, the state machine is a pushdown automaton with a stack of finite state machines having a plurality of finite state machines.

A query element is a conditional expression obtained by breaking down the input query data 400 and specifying an attribute, element, or value corresponding to query's interest contained in the input EXI stream 500. There are two types of query elements. One type is a query element for making a value definitive after a finite number (n) of certain state transitions contained in a grammar. This is used to determine whether or not a certain tag exists, for example. The confirmation on the existence of a tag e can be expresses by a query element q1 that makes TRUE for n=1 definitive for a state transition SE(e) that makes the existence of the tag e definitive.

On the other hand, for the confirmation on the nonexistence of the tag e, FALSE is made definitive by the same query element (q1) and, at the same time, a query element (q2) for making TRUE definitive for a transition making the fact that the tag e cannot appear thereafter definitive is generated and the exit condition is set to q1 or q2.

Another example of the query elements is a query element corresponding to a value. Determination such as whether a numerical value is larger or smaller than or equal to another or according to a function for determining a character string (regular expression matching, equivalence, head matching, tail matching, etc.) is made, and TRUE OR FALSE is made definitive on the basis of a result of the determination.

The following two query elements are obtained from the input query data 400 described above:
QE1: the value of /measurement/points/point/type is temperature; and
QE2: the value of /measurement/points/point/value is equal to or larger than 40.

In the present embodiment, the input query data 400 are described using an XPath subset. A syntax rule corresponding to an unabbreviated path composed mainly of node names in XPath is an input element, which will be hereinafter referred to as a path. The node names are separated by slashes, such as /node1/node2/@attrib. This means a value of an attribute attrib under an element node2 under an element node1 in the XML. Two types of queries are assumed as examples of the queries in the present embodiment, which are a query to check whether or not a value exists in a specified path and a query to check whether or not a specified value satisfies a predetermined condition. A query to check whether or not a value exists in a specified path is described as /node1/node2/@attrib, for example, and the query is TRUE if the path exists. A query to check whether or not a specified value satisfies a predetermined condition is described as /node1/node2[@a=“test”], for example, and the query is TRUE if there is an element node2 under an element node1 and if the value of an attribute a of the element node2 is “test”.

Accordingly, the grammar generating unit 100 breaks down respective terms of the input query data 400 input thereto simply as query elements. Furthermore, as another more optimal method, optimization can be done by replacing a test on the nonexistence of a value (a negative form of a test on the existence of a value), if any, for example, by a condition that the value (tag) cannot have appeared, or more specifically, a condition that the tag has not been appeared and that there is a tag appearing after the tag according to a syntax defined by the XML schema.

Although the nonexistence of a tag cannot usually be determined before parsing of all XML documents is completed, determination on query elements can be made in earlier stages by replacement with syntax defined by the schema.

The exit condition is a logical expression generated by combining outputs of respective query elements. A final output requested by the input query data 400 is expressed by the exit condition. For example, when three elements q1, q2, and q3 are present as query elements, the exit condition can be expressed by a format such as (q1 [symbol] q2) [symbol] q3. This can express, for example, a condition “student or nonage living with parents” when an input of an XML document is a customer profile, q1 represents “the value of an age element is 20 or smaller”, q2 represents “the value of an occupation element is student”, and q3 represents “a parent element exists under a family-living-together element”. The grammar generating unit 100 inputs the query elements generated as described above and the exit condition to the document processing device 200.

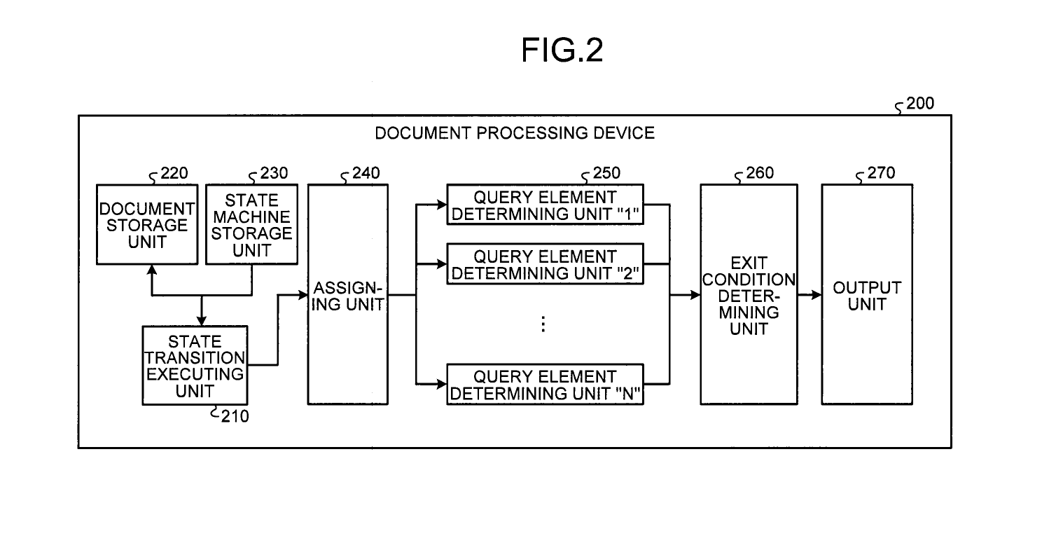

Next, a detailed configuration of the document processing device 200 will be described with reference to FIG. 2. The document processing device 200 includes a state transition executing unit 210, a document storage unit 220, a state machine storage unit 230, an assigning unit 240, query element determining units 250, an exit condition determining unit 260, and an output unit 270. In the present embodiment, an example in which the number of query element determining units 250 is N and the number of exit condition determining unit 260 is one is described. The document storage unit 220 receives an input EXI stream 500 and stores the EXI stream 500. The EXI stream 500 is input one data piece by one data piece, and after one data piece satisfies the exit condition, the state transition executing unit 210 receives input of the next data piece.

A state machine generated by the grammar generating unit 100 is input to and stored by the state machine storage unit 230. The state machine storage unit 230 is therefore set up by the state machine generated by the grammar generating unit 100. Note that the state machine storage unit 230 may store a plurality of state machines. The state transition executing unit 210 also executes state transitions of the EXI stream 500 stored by the document storage unit 220 according to the stored state machine associated with the EXI stream 500, and updates the current state of the EXI stream 500 stored by the document storage unit 220 each time a transition is executed. The associated state machine can be determined on the basis of the association of a declared XML schema 300 in the EXI stream 500.

The state transition executing unit 210 also informs the assigning unit 240 of the content of the transition each time a transition is executed. The assigning unit 240 selects which of the query element determining units 250 to inform of the information on the basis of the informed content of the transition. The query element determining units 250 receive a query element generated by the grammar generating unit 100 as input, and generated according to the query element. Specifically, the number of query element determining units 250 that are generated is the number of input query elements, and two query element determining units 250 are generated in the example described above.

The query element determining units 250 can output any of three values, which are TRUE, FALSE, and UNKNOWN, for a certain input document. TRUE is a positive output indicating that an attribute, element, or value corresponding to query's interest in an input EXI stream 500 satisfies a condition. FALSE is a negative output indicating that an attribute, element, or value corresponding to query's interest in the input structured document does not satisfy a condition. UNKNOWN is a standby output indicating that determination on a condition cannot yet be made.

The query element determining units 250 thus outputs UNKNOWN as a value until the output of TRUE or FALSE is made definitive. Then, as the parsing of a sequence of elements (input sequence) constituting the input EXI stream 500 progresses, the output value of TRUE or FALSE is made definitive. An output value for a query element once made definitive does not change thereafter. The query element determining unit 250 outputs an output value of TRUE, FALSE or UNKNOWN to the exit condition determining unit 260.

The exit condition determining unit 260 expresses whether or not the input XML stream 500 satisfies the condition of the input query data 400 with a combination of the conditions of the output values output from the query element determining units 250, and outputs one of TRUE, FALSE, and UNKNOWN. The exit condition at the exit condition determining unit 260 is also set by the exit condition generated by the grammar generating unit 100. In the example of the present embodiment, QE1 and QE2 is the exit condition, which is satisfied when TRUE is input from both QE1 and QE2.

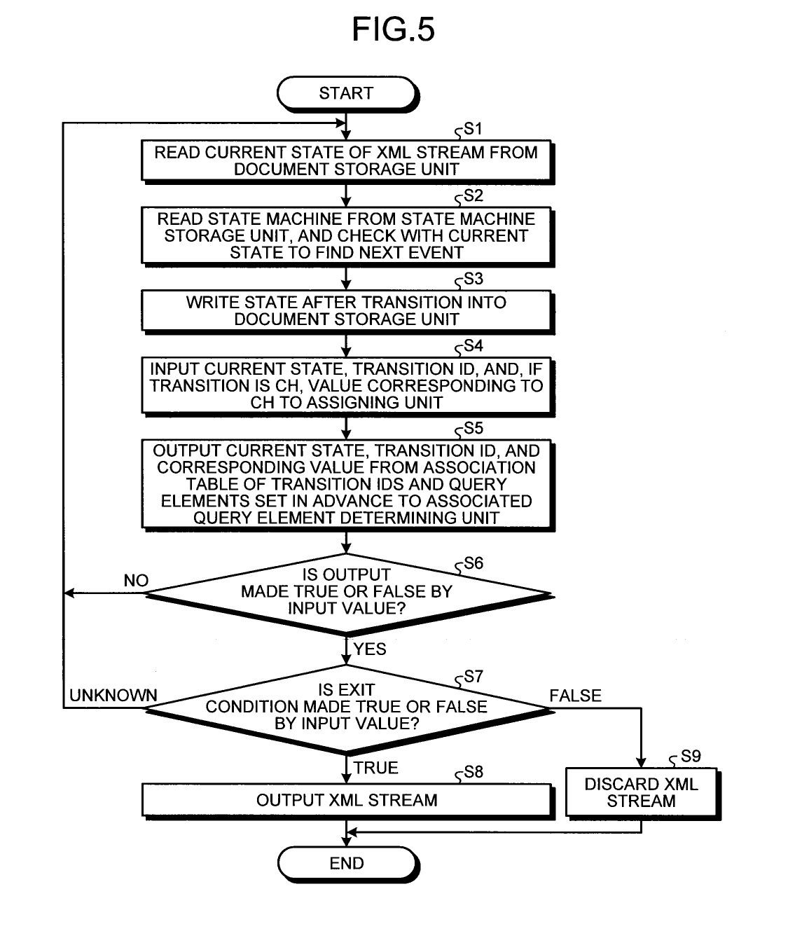

A flow of detailed processing will be described below with reference to the flowchart of FIG. 5. First, the state transition executing unit 210 reads a current state of an XML stream 500 from the document storage unit 220 (step S1). Subsequently, the state transition executing unit 210 obtains a state machine associated with the read XML stream 500 from the state machine storage unit 230 to find the next event (transition) from the current state (step S2). The state transition executing unit 210 then executes the event (transition), and writes the current state resulting from the transition into the document storage unit 220 (step S3). Note that this operation is equivalent to a normal pushdown automaton having a stack, and the “current state” has a stack of IDs of current state machines and an ID of the current state according to an active state machine on the top of the stack.

In addition to executing the state transition, the state transition executing unit 210 inputs the current state after the transition, an event ID, and, if the event is CH (an event type meaning a “value” in the EXI standard), a value corresponding to CH to the assigning unit 240 (step S4). The assigning unit 240 can determine the event ID for a query element, that is, which event will be the event used for determination on the condition of the query element on the basis of the query element input in advance from the grammar generating unit 100 and the state machine. Accordingly, the assigning unit 240 outputs the current state, the event ID, and the corresponding value to the query element determining unit 250 associated with the input event ID (step S5). If a plurality of query elements is associated with one event ID, the output is provided to a plurality of query element determining units 250 at the same time.

The query element determining units 250 each have a state variable therein, update the state variable in response to the input, and determine whether or not an output of TRUE or FALSE is made definitive as a result of the update (step S6). Examples of the state variable include the number of transitions, a value to be compared with, and a value of a stack that is a precondition of a transition.

If the output of the query element determining unit 250 remains UNKNOWN (step S6: No), the processing returns to step S1 and subsequent processing is repeated. If the output of the query element determining unit 250 is TRUE or FALSE (step S6: Yes), the exit condition determining unit 260 that has received the output determines whether or not the exit condition is made definitive to be TRUE or FALSE by the input value (step S7). The determination by the exit condition determining unit 260 may be performed when an output from the query element determining unit 250 changes or may be performed in a certain cycle.

If the exit condition is made definitive to be TRUE by the input value (step S7: TRUE), the output unit 270 outputs an XML stream 600, and the processing is terminated (step S8). If the exit condition is made definitive to be FALSE by the input value (step S7: FALSE), the state transition executing unit 210 discards the input XML stream 500, and the processing is terminated (step S8). If the exit condition remains UNKNOWN as a result of the input value (step S7: UNKNOWN), the processing returns to step S1 and subsequent processing is repeated.

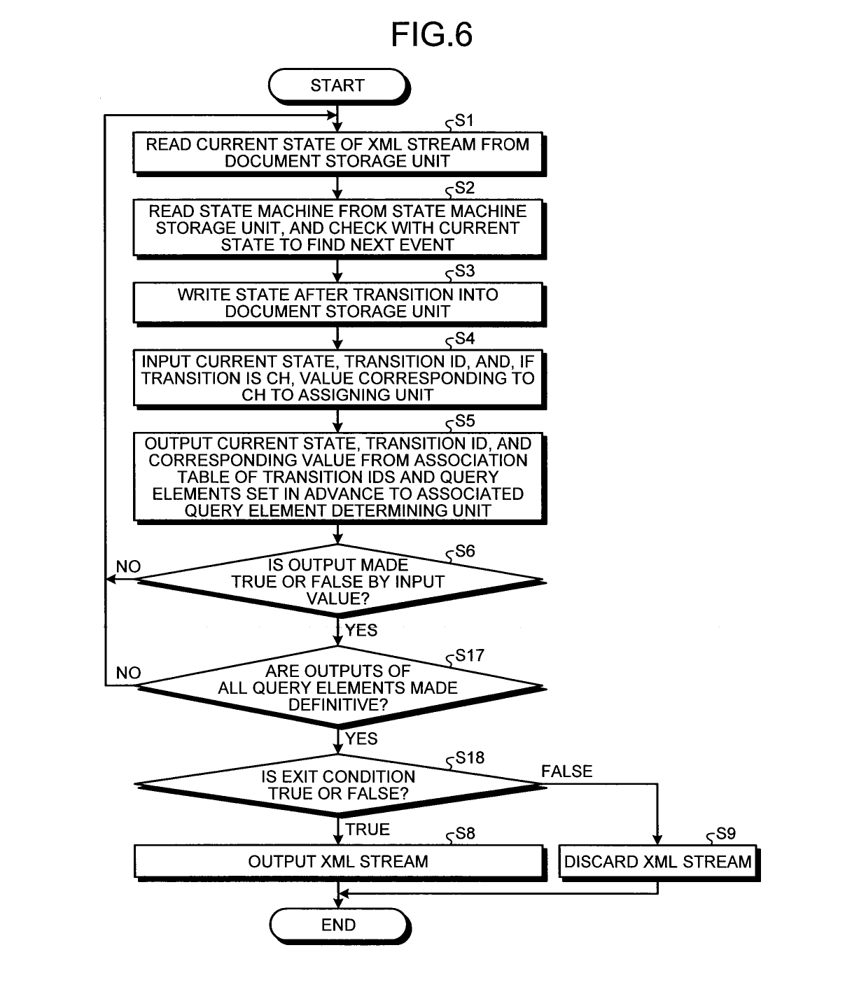

As another example, processing according to a flowchart of FIG. 6 is also possible. In FIG. 6, processes similar to those of FIG. 5 will be designated by the same step numbers, and only processes different therefrom will be described. As illustrated in FIG. 6, the exit condition determining unit determines whether or not outputs from all the query element determining units 250 are made definitive (step S17). If it is determined that all the outputs are not made definitive (step S17: No), the processing from step S1 is repeated until all the outputs are made definitive. If, on the other hand, it is determined that all the outputs are made definitive (step S17: Yes), the exit condition determining unit 260 determines whether the output thereof is TRUE or FALSE (step S18). Since the outputs from all the query element determining units 250 are made definitive, the output from the exit condition determining unit 260 will be either TRUE or FALSE.

A case in which the processing described above is applied to the XML stream 500 illustrated in FIGS. 4A and 4B will be described. In an EXI stream, a stack of state machines is pushed by an SE event and popped by an EE event. Specifically, in the stage of an event CH (12345) in FIGS. 4A and 4B, the state machines are stacked in the order of SD, SE(measurement), and SE(ID). Then, in the state of CH(temperature), SE(ID) is popped by EE(ID), and the stack contains SD, SE(measurement), SE(points), SE(point), and SE(type). Since this corresponds to a path /measurement/points/point/type and the value specified by CH is temperature, the condition of “QE1: the value of /measurement/points/point/type is temperature is satisfied”. As a result, a query element determining unit 250 associated with QE1 outputs TRUE to the exit condition determining unit 260 at this point.

Similarly, at CH(40.5), the stack contains SD, SE(measurement), SE(points), SE(point), and SE(value). Since this corresponds to a path /measurement/points/point/value and the value specified by CH is 40.5, the condition of “QE2: the value of /measurement/points/point/value is equal to or larger than 40” is satisfied. As a result, a query element determining unit 250 associated with QE2 outputs TRUE to the exit condition determining unit 260 at this point.

Since the exit condition is satisfied at this point, state transitions are not executed for subsequent part of the input sequence and the exit condition determining unit 260 determines the output to be TRUE.

With the document processing device 200 according to the present embodiment described above, it is possible to parse and evaluate an XML stream 500 in parallel by query element determining units 250 obtained by breaking down input query data 400 by conditions, and the time required for parsing is shortened since the conditional expression itself is described in a simple structure. As a result, the determination as to whether or not an XML stream 500 satisfies query data 400 can be processed at high speeds and the speed at which a structured document is processed can be increased.

While a configuration in which the grammar generating unit 100 is not included in the document processing device 200 is presented in the embodiment described above, the functions of the grammar generating unit 100 may be implemented in the document processing device 200.

Furthermore, the document processing device presented in the embodiment described above can be realized as a device as follows. For example, the document processing device can be used as a content-based network switch that assigns an input EXI stream to a plurality of outputs. In this case, a plurality of exit condition determining units corresponding to the outputs, respectively, may be provided, the same processing may be performed on the EXI stream, and the EXI stream may be output to a destination corresponding to a satisfied exit condition. In providing the exit condition determining units in parallel, the exit condition determining units may simply be parallelized, or the exit condition determining units may be ranked by priority and, when an output of an exit condition with a certain priority is made definitive to be TRUE, determination on subsequent exit conditions may be stopped.

Furthermore, the document processing device may be used like a processor in such a manner that the EXI stream is read on up to a part corresponding to a condition specified by input query data 400 without performing determination and only the part corresponding to the corresponding condition is examined in detailed. IN this case, the output unit may output the current state at the point of determination by the document processing device and the location of determined CH in addition to the EXI stream. An application that has received the output can continue parsing immediately after the condition specified by the input query data and satisfied at the query element determining units instead of parsing the EXI stream from the beginning. As a result, application processing can be speeded up.

The document processing device according to the embodiments described above includes a control device such as a CPU, a storage device such as a read only memory (ROM) and a random access memory (RAM), an external storage device such as an HDD and a CD drive, a display device such as a display, and an input device such as a key board and a mouse, which is a hardware configuration utilizing a common computer system.

Programs to be executed by the document processing device according to the embodiments described above are recorded on a computer readable recording medium such as a CD-ROM, a flexible disk (FD), a CD-R, and a digital versatile disk (DVD) in a form of a file that can be installed or executed, and provided as a computer program product.

Alternatively, the programs in the embodiments described above may be stored on a computer system connected to a network such as the Internet, and provided as a computer program product by being downloaded via the network. Still alternatively, the programs to be executed by the document processing device according to the embodiments described above may be provided or distributed as a computer program product through a network such as the Internet.

Still alternatively, the programs in the embodiments described above may be embedded on a ROM or the like in advance and provided as a computer program product.

The programs to be executed by the document processing device according to the embodiments described above have a modular structure including the respective units described above. In an actual hardware configuration, a CPU (processor) reads the verification programs from the storage medium mentioned above and executes the programs, whereby the respective units are loaded on a main storage device and generated thereon.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A document processing device comprising:
a state machine storage unit configured to store a state machine generated from a grammar defining a structured document;
a document storage unit configured to store a binarized structured document being processed;
a document receiving unit configured to
receive an input of the structured document, and
store the structured document into the document storage unit;
a state transition executing unit configured to
execute a state transition of the structured document stored in the document storage unit according to the stored state machine associated with the structured document, and
update a current state of the structured document stored in the document storage unit each time a transition is executed;
a query element determining unit configured to
determine whether an attribute, element, or value corresponding to query's interest in the received structured document is satisfied for each of query elements into which query data for specifying conditions for the structured document is broken down for respective conditions,
output one of a positive output indicating that a condition is satisfied, a negative output indicating that a condition is not satisfied, and a standby output indicating that a condition is not allowed to be determined yet as an output value, and
output the standby output until the positive output or the negative output is output;
an exit condition determining unit configured to output one of a positive output indicating that a condition is satisfied, a negative output indicating that a condition is not satisfied, and a standby output indicating that a condition is not allowed to be determined yet as an output value of an exit condition expressed by a logical expression combining conditions of the output values output from the query element determining unit, the exit condition expressing whether the received structured document satisfies the conditions of the query data; and
an output unit configured to output the structured document, wherein
the state transition executing unit executes the transition while the exit condition determining unit outputs the standby output, and discards the received structured document being processed and instructs the document receiving unit to receive a next structured document when the exit condition determining unit outputs the negative output, and
the output unit outputs the structured document being processed when the exit condition determining unit outputs the positive output.

2. The device according to claim 1, further comprising
a grammar generating unit configured to
receive an input of the grammar defining the structured document and the query data,
generate the state machine based on the grammar, and
generate the query elements and the exit condition based on the grammar and the query data.

3. The device according to claim 1, wherein the query elements are query elements to make a value definitive when a finite number of particular state transitions contained in the state machine are executed or query elements to determine whether a value of a specified element satisfies the condition.

4. The device according to claim 1, comprising a plurality of exit condition determining units, wherein
the exit condition determining units each have a corresponding destination set therefor, and
when any one of the exit condition determining units satisfies the exit condition and outputs the positive output, the output unit outputs the structured document to the destination corresponding to the any one of the exit condition determining units.

5. A computer program product comprising a computer-readable medium containing a program executed by a computer, the program causing the computer to execute:
receiving an input of a structured document, and
storing the structured document into a document storage unit configured to store a binarized structured document being processed;
executing a state transition of the structured document stored in the document storage unit according to a state machine associated with the structured document, the state machine being generated from a grammar defining the structured document and stored in a state machine storage unit;
updating a current state of the structured document stored in the document storage unit each time a transition is executed;
determining whether an attribute, element, or value corresponding to query's interest in the received structured document is satisfied for each of query elements into which query data for specifying conditions for the structured document is broken down for respective conditions;
outputting one of a positive output indicating that a condition is satisfied, a negative output indicating that a condition is not satisfied, and a standby output indicating that a condition is not allowed to be determined yet as an output value;
outputting the standby output until the positive output or the negative output is output;
outputting one of a positive output indicating that a condition is satisfied, a negative output indicating that a condition is not satisfied, and a standby output indicating that a condition is not allowed to be determined yet as an output value of an exit condition expressed by a logical expression combining conditions of the output values, the exit condition expressing whether the received structured document satisfies the conditions of the query data;
outputting the structured document;
executing the transition while the standby output is output as the output value of the exit condition;
discarding the received structured document being processed and instructing the document receiving unit to receive a next structured document when the negative output is output as the output value of the exit condition; and
outputting the structured document being processed when the positive output is output as the output value of the exit condition.
